(19) United States
(12) Patent Application Publication
(10) Pub. No.: US 2008/0066787 A1
(43) Pub. Date: Mar. 20, 2008

(54) Treatment method and treatment apparatus for substrate

(75) Inventor: Koichiro Saga, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation

(21) Appl. No.: 11/790,536

(22) Filed: Apr. 26, 2007

(30) Foreign Application Priority Data
May 9, 2006 (JP) P2006-130494

(51) Int. Cl. F15B 21/06

(52) U.S. Cl. 134/42; 134/184

(57) ABSTRACT

A method for treating a substrate using a supercritical fluid as a medium is disclosed. The method includes the steps of mixing the supercritical fluid with a chemical under a pressure higher than a pressure for treating the substrate, and subsequently treating the substrate with the supercritical fluid mixed with the chemical at the pressure for treating the substrate.

### CROSS REFERENCES TO RELATED APPLICATIONS

The present invention contains subject matter related to Japanese Patent Application JP 2006-130494 filed in the Japanese Patent Office on May 9, 2006, the entire contents of which are incorporated herein by reference.

### BACKGROUND OF THE INVENTION

1. Field of the Invention

The present invention relates to a method and an apparatus for treating a substrate using a supercritical fluid as a medium.

2. Description of the Related Art

Japanese Examined Patent Application Publication No. 7-7756 and Japanese Unexamined Patent Application Publication No. 2005-72568 have recently disclosed a method for treating an electronic substrate with a supercritical fluid in place of a wet process or vacuum dry process of the related art in cleaning, etching, and resist stripping in a semiconductor wafer process.

A supercritical fluid refers to a fluid having a phase in which each substance is present at a supercritical temperature specific to the substance or higher and at a supercritical pressure specific to the substance or higher.

A substance in a supercritical state has a unique property in that the solubility of the substance in another liquid or solid is almost equal to that of the substance in a liquid state; however, the substance has a viscosity or density considerably smaller than that of the substance in a liquid state, but the substance has an extremely large diffusion coefficient. Specifically, the substance in a supercritical state may be a liquid in a gaseous state.

Supercritical fluids used for treating a substrate include carbon dioxide, ammonia, water, alcohols, low-molecular-weight aliphatic saturated hydrocarbons, benzene, and diethyl ether. Alternatively, many other substances that are generally observed as being in a supercritical state may be used.

Among the above substances, carbon dioxide in particular, has a supercritical temperature of 31.3° C., close to room temperature, and thus it may be easily handled and can treat a subject without exposing the subject to a high temperature environment. Therefore, a carbon oxide supercritical fluid is most frequently used for treating a substrate.

However, supercritical carbon dioxide has dissolution properties similar to a non-polar organic solvent. Since a single element supercritical carbon dioxide has a selective dissolution property to dissolve substances, the substances to be removed may be limited only to a certain extent in treating a substrate.

For example, the single element supercritical carbon dioxide is effective for removing a low-molecular-weight organic substance and removing grease or wax. However, single element supercritical carbon dioxide is not effective for removing fine particles formed of an inorganic mixed compound, fiber, or an organic polymer compound, such as plastic, and a film of an inorganic substance, for example.

Japanese Unexamined Patent Application Publication No. 2003-224099 and Japanese Patent No. 3564101 have, for example, disclosed a study of improving the dissolution properties of supercritical carbon dioxide by adding about several percent of a second chemical substance (chemical), such as an etchant, solubilizer, or cleaner.

Thus, the single element supercritical carbon dioxide may remove the above-described substances that are difficult to be removed by treating a substrate with a chemical in this manner.

A method for treating a substrate using the above-described chemical will be described with reference to an apparatus for the treatment shown in FIG. 1.

### First, the apparatus for treating a substrate of FIG. 1 will be described.

The treatment apparatus of FIG. 1 according to an embodiment of the present invention has a treatment apparatus main body 110; a carbon dioxide supply device 120 for supplying carbon dioxide to the treatment apparatus main body 110; a chemical supply device 130 for supplying a chemical to the treatment apparatus main body 110; a mixing tank 140 of dissolving the supercritical carbon dioxide and the chemical to be supplied to the treatment apparatus main body 110; and a gas-liquid separation-collection device 160 for separating a fluid discharged from the treatment apparatus main body 110 into carbon dioxide gas and a chemical to collect the chemical.

There are provided, between the carbon dioxide supply device 120 and the mixing tank 140, a cooling device 121 for cooling carbon dioxide supplied from the carbon dioxide supply device 120 into a liquid; and a pressurizing device 122 and a heating device 123 for transforming the liquid carbon dioxide into a supercritical state. There also are provided a pressurizing device 132 and a heating device 133 for controlling a temperature and pressure of the chemical between the chemical supply device 130 and the mixing tank 140. Opening-closing valves 124 and 131 are provided for the carbon dioxide supply device 120 and the chemical supply device 130, respectively.

There is provided a pressure control valve 151 for controlling the pressure between the substrate treatment tank 110 and the gas-liquid separation-collection device 160 in the treatment apparatus main body 110.

The treatment apparatus main body 110 is formed as a plate-like container and includes a treatment tank 111 in which a substrate 101 is accommodated to be treated and a heating device 115 incorporated in the treatment tank 111. The main body has heating devices 116 and 117 in front of and behind the treatment tank 111.

Next, a treatment method using the above treatment apparatus will be described.

First, a substrate 101 to be treated is accommodated in the treatment tank 111 and a cover is closed, so that the treatment tank 111 is sealed.

Then, the pressure control valve 151 is adequately closed so that the pressure in the treatment tank 111 may be controlled to retain a predetermined treatment pressure (26 MPa, for example).

Then, the opening-closing valve 124 is opened to supply carbon dioxide from the carbon dioxide supply device 120. The supplied carbon dioxide is transformed into a liquid by the cooling device 121. Then, the liquid is pressurized to 7.3 MPa or higher using the pressurizing device 122 and heated to 31.1° C. or higher using the heating device 123 so as to be transformed into supercritical carbon dioxide. The supercritical carbon dioxide is introduced into the mixing tank 140.

The opening-closing valve 131 is opened to supply a chemical from the chemical supply device 130. The chemical is pressurized to 7.3 MPa or higher using the pressurizing device 132 and introduced into the mixing tank 140.

The introduced supercritical carbon dioxide and chemical are mixed in the mixing tank 140 in this manner. The supercritical carbon dioxide mixed with the chemical is supplied to the treatment tank 111 from the mixing tank 140.

When the pressure in the treatment tank 111 reaches a predetermined treatment pressure or higher, the pressure control valve 151 is opened, and the supercritical carbon dioxide containing the chemical is discharged to the gas-liquid separation-collection device 160. The pressure and temperature in the treatment tank 111 may be kept constant when the supercritical carbon dioxide with which the treatment tank 111 is filled is appropriately discharged in this manner.

A fluid discharged to the gas-liquid separation-collection device 160 from the pressure control valve 151 is adiabatically expanded using the pressure control valve 151, so that the pressure of the fluid is returned to atmospheric pressure. When the pressure of the fluid is returned to atmospheric pressure, the carbon dioxide in a supercritical state is transformed into a gas, so that the fluid may be separated into carbon dioxide gas and a liquid chemical.

The chemical separated from the carbon dioxide is collected in the gas-liquid separation-collection device 160 as a discharged liquid. A substance removed or extracted by the supercritical fluid in the treatment tank 111 is dissolved in or accompanied with the chemical and accumulated in the gas-liquid separation-collection device 160.

On the other hand, the carbon dioxide is discharged from the gas-liquid separation-collection device 160 as a gas. The discharged carbon dioxide also may be condensed again and collected.

The collected chemical or carbon dioxide also may be reprocessed so as to be usable and reused.

As described above, in the method of the related art for treating a substrate using the treatment apparatus of FIG. 1, a chemical and supercritical carbon dioxide are introduced into the mixing tank 140 under a pressure equal to that for treating the substrate when the chemical is dissolved in the supercritical carbon dioxide. The solubility of the chemical is improved by introducing the chemical and the carbon dioxide into the mixing tank 140 to dissolve the chemical in the supercritical carbon dioxide and then introducing the chemical and the supercritical carbon dioxide into the substrate treatment tank 110.

As a method of improving the performance of treating a substrate using an apparatus similar to the above apparatus, Japanese Unexamined Patent Application Publication No. 2005-72568, for example, discloses a method of improving the performance of treating a substrate by increasing the flow rate of supercritical carbon dioxide on a surface of the substrate in the treatment tank 111.

In this method, a shear stress of the fluid on the substrate surface is improved by increasing the flow rate of the supercritical carbon dioxide on the substrate surface. Thus, fine particles attached to the substrate may be removed efficiently by a high shear stress generated from a high flow rate of the supercritical carbon dioxide.

### SUMMARY OF THE INVENTION

In the method of the related art for treating a substrate using the treatment apparatus shown in FIG. 1, a chemical may be sufficiently dissolved in a supercritical fluid before introducing the chemical and the supercritical fluid into the treatment tank 111 when the total flow rate is as low as several tens mL/min or lower. However, when the flow rate is as high as several tens to several thousands mL/min, the chemical may not be homogeneously dissolved in the supercritical fluid even when the chemical and the supercritical fluid are mixed and stirred in the mixing tank 140.

When the chemical may not be homogeneously dissolved in the supercritical fluid in the mixing tank 140, the supercritical carbon dioxide and the chemical are separated before the supercritical carbon dioxide and the chemical are supplied to the treatment tank 111. Accordingly, a substrate may not be uniformly treated in the treatment tank 111, and a surface of the substrate is poorly treated.

According to embodiments of the present invention, there are provided a method and an apparatus for treating a substrate using supercritical carbon dioxide as a medium which may improve the ability to treat a substrate by uniformly mixing supercritical carbon dioxide with a chemical even when a flow rate is high.

A method for treating a substrate using a supercritical fluid as a medium according to an embodiment of the present invention includes the steps of mixing the supercritical fluid with a chemical under a pressure higher than the pressure for treating the substrate, and then treating the substrate by the supercritical fluid mixed with the chemical under the pressure for treating the substrate.

An apparatus for treating a substrate according to an embodiment of the present invention includes a substrate treatment tank formed to accommodate a substrate into which a supercritical fluid is introduced as a medium to treat the substrate and a mixing device for mixing the supercritical fluid with a chemical provided upstream of the substrate treatment tank in which a pipe divided by a branching valve is provided between the substrate treatment tank and the mixing device, and the pipe divided by the branching valve has a pressure control valve.

In the method for treating a substrate according to the above-described embodiment of the present invention, a supercritical fluid is mixed with a chemical under a high pressure, so that the solubility of the chemical in the supercritical fluid may be improved. Thus, the supercritical fluid may be mixed homogeneously with the chemical even at a high flow rate.

In the apparatus for treating a substrate according to the above-described embodiment of the present invention, the flow of the fluid from the mixing device may be switched from the substrate treatment tank to the branched pipe by using the branching valve, and the pressure in the mixing device may be controlled by the pressure control valve independently from the substrate treatment tank. Thus, a supercritical fluid may be mixed homogeneously with a chemical in the mixing device under a pressure higher than in the substrate treatment tank even when the flow rate is increased.

According to the above-described embodiment of the present invention, a supercritical fluid homogeneously mixed with a chemical may be supplied to a substrate treatment tank even when the flow rate of the supercritical fluid is increased. Thus, a substrate may be uniformly treated efficiently.

### BRIEF DESCRIPTION OF THE DRAWINGS

FIG. 1 is a configuration diagram showing an apparatus of the related art for treating a substrate using a supercritical fluid.

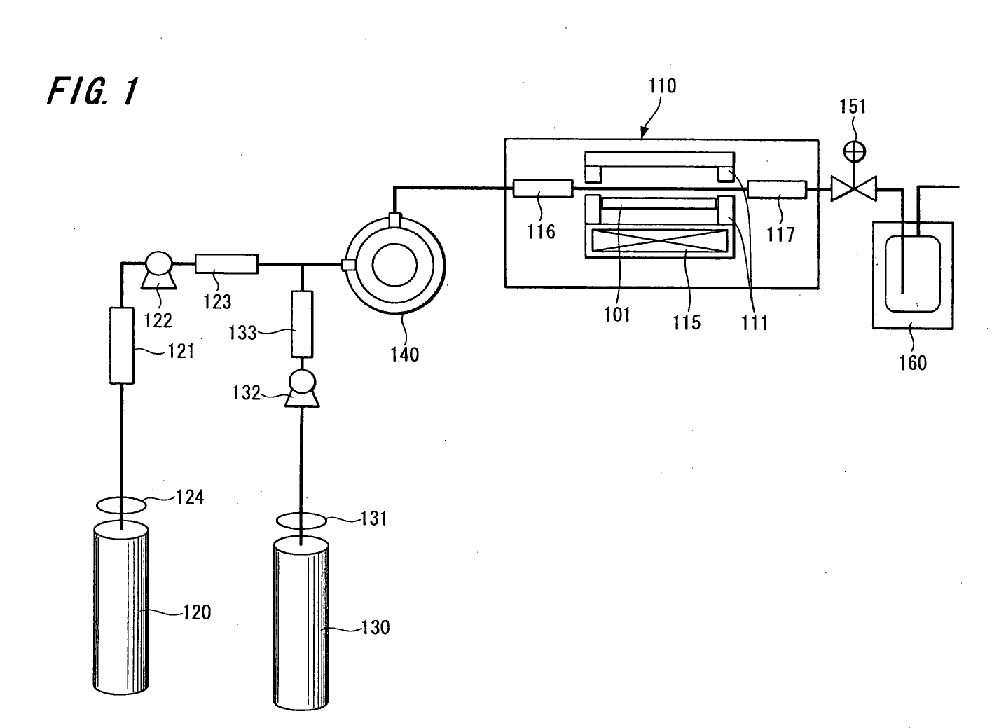

FIG. 2 is a configuration diagram showing a treatment apparatus according to a first embodiment of the present invention.

FIG. 3 is a configuration diagram showing a treatment apparatus according to a second embodiment of the present invention.

### DESCRIPTION OF THE PREFERRED EMBODIMENTS

Embodiments of the present invention will be described below with reference to drawings.

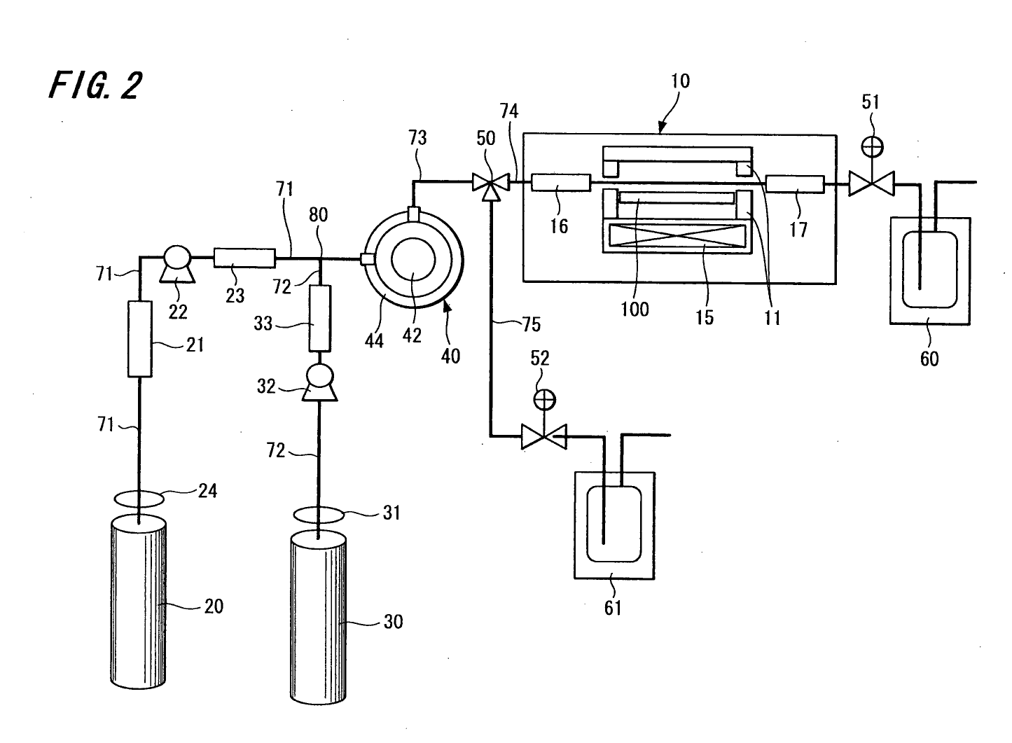

First, a treatment apparatus according to a first embodiment of the present invention is shown in FIG. 2.

The treatment apparatus of FIG. 2 is a single wafer process apparatus and has a treatment apparatus main body 10, a carbon dioxide supply device 20, a chemical supply device 30, a mixing tank 40, a three-way valve 50, and gas-liquid separation-collection devices 60 and 61. The carbon dioxide supply device 20 supplies carbon dioxide to the treatment apparatus main body 10. The chemical supply device 30 supplies a second chemical substance (chemical), such as an etchant, solubilizer, or cleaner, to the treatment apparatus main body 10. The mixing tank 40 dissolves the supercritical carbon dioxide and the chemical to be supplied to the treatment apparatus main body 10. The gas-liquid separation-collection devices 60 and 61 separate the discharged supercritical carbon dioxide into carbon dioxide gas and a chemical to collect the chemical and the carbon dioxide.

The treatment apparatus main body 10 is formed as a plate-like container and has a treatment tank 11 in which a substrate 100 to be treated is accommodated and treated; and a heating device 15 is incorporated in the treatment tank 11. The main body has heating devices 16 and 17 in front of and behind the treatment tank 11.

There are provided downstream of the treatment apparatus main body 10 a first pressure control valve 51 for controlling the pressure in the treatment apparatus main body 10 and the gas-liquid separation-collection device 60 for separating a fluid discharged from the treatment apparatus main body 10 into carbon dioxide gas and a chemical to collect the chemical.

The carbon dioxide supply device 20 is formed of a carbon dioxide cylinder in which pressurized and liquidated carbon dioxide is contained.

An opening-closing valve 24 is provided for the carbon dioxide supply device 20. A pipe 71 is connected to the carbon dioxide supply device 20. The pipe 71 connects the carbon dioxide supply device 20, a cooling device 21 for cooling and liquidating CO₂ gas, and a pressurizing device 22 and a heating device 23 for transforming the liquid carbon dioxide into a supercritical state to each other, and is connected to the mixing tank 40.

The pressurizing device 22 is formed of a pressurizing pump or the like, and the heating device 23 is formed of a line heater or the like.

An opening-closing valve 31 is provided for the chemical supply device 30. A pipe 72 is connected to the chemical supply device 30. The pipe 72 connects the chemical supply device 30, a pressurizing device 32, and a heating device 33 to each other, and is connected to the pipe 71 in which supercritical carbon dioxide flows.

Since supercritical carbon dioxide flowing in the pipe 71 is brought into contact with a chemical flowing in the pipe 72 in a junction of the pipe 71 and the pipe 72, the junction forms a mixing device 80 for mixing the supercritical carbon dioxide with the chemical.

The mixing tank 40 has a solubility observation window 42 for observing whether or not carbon dioxide is mixed with an additive; and a heating device 44, such as a built-in heater, is incorporated in an outer wall of the tank.

The pipe 71 into which a fluid mixture of supercritical carbon dioxide with a chemical flows and a pipe 73 from which the fluid is discharged are connected to the mixing tank 40.

The three-way valve 50 is provided between the mixing tank 40 and the treatment apparatus main body 10. The three-way valve 50 is formed to connect the pipe 73 at the side of the mixing tank 40 to a pipe 74 at the side of the treatment apparatus main body 10 and branch a pipe 75 from the pipe 73 and the pipe 74.

The three-way valve 50 is formed so that a supply route of a fluid flowing from the pipe 73 at the side of the mixing tank 40 may be switched between the pipe 74 and the pipe 75.

A second pressure control valve 52 is provided for the pipe 75 divided by the three-way valve 50. The pipe 75 is provided with a gas-liquid separation-collection device 61 for separating a fluid discharged through the three-way valve 50 and the second pressure control valve 52 into carbon dioxide gas and a chemical and to collect the chemical.

The second pressure control valve 52 has a configuration in which the valve may control the pressure in the mixing tank 40 and the mixing device 80 independently from the treatment apparatus main body 10 when the three-way valve 50 blocks the pipe 74 and connects the pipe 73 to the pipe 75.

Next, a method for treating a substrate using the treatment apparatus according to the above-described first embodiment will be described.

First, a substrate 100 to be treated is accommodated in the treatment tank 11 and a cover is closed, so that the treatment tank 111 is sealed.

Then, the first pressure control valve 51 is adequately closed so that the pressure in the treatment tank 11 may be controlled to retain a predetermined treatment pressure (26 MPa, for example). The three-way valve 50 is switched so that a fluid from the pipe 73 is supplied to the pipe 74.

Then, the opening-closing valve 24 is opened to supply carbon dioxide from the carbon dioxide supply device 20.

The carbon dioxide supplied from the carbon dioxide supply device 20 is cooled using the cooling device 21 and transformed into a liquid state. The carbon dioxide in a liquid state is pressurized to 7.3 MPa or higher using the pressurizing device 22 and heated to 50° C. by the heating device 23 and thus is transformed into a supercritical state.

The carbon dioxide in a supercritical state is introduced into the treatment apparatus main body 10 through the mixing tank 40 and the three-way valve 50.

The pressure in the treatment tank 11 is controlled to be a pressure for treating the substrate 100 (26 MPa, for example) by using the first pressure control valve 51. When the pressure in the treatment tank 11 includes a predetermined pressure or higher, the first pressure control valve 51 is opened to discharge the supercritical carbon dioxide, so that the pressure in the treatment tank 11 may be kept constant. The supercritical carbon dioxide discharged from the treatment tank 11 is discharged to the gas-liquid separation-collection device 60 by opening the first pressure control valve 51.

Subsequent treatment of the substrate may be rapidly performed by pre-controlling the pressure in the treatment tank 11 at a predetermined treatment pressure.

Then, a flow of the supercritical carbon dioxide from the pipe 73 is switched from the pipe 74 to the pipe 75 by using the three-way valve 50. Then, the second pressure control valve 52 is adequately closed so that the pressure in the mixing tank 40 may be controlled to be higher than the. treatment pressure in the treatment tank 11 (30 MPa, for example).

Thereafter, the pressure in the mixing tank 40 is higher than the treatment pressure in the treatment tank 11 with the supercritical carbon dioxide supplied from the pipe 71.

Then, the opening-closing valve 31 is opened to supply a chemical from the chemical supply device 30.

The chemical is controlled to be at a predetermined pressure and temperature using the pressurizing device 32 and the heating device 33 and is supplied to the pipe 71 through the pipe 72. At this time, the chemical is mixed at a ratio of 1 to 5 wt % based on the carbon dioxide already heated and pressurized, for example.

The supercritical carbon dioxide and the chemical are brought into contact with each other in the mixing device 80, and are supplied to the mixing tank 40 through the pipe 71.

The supercritical carbon dioxide is not homogeneously mixed with the chemical for a certain time after the start of mixing. Thus, a phase of the supercritical carbon dioxide and a phase of the chemical are separated in the mixing tank 40, and an interface between the two phases may be observed from the solubility observation window 42.

The supercritical carbon dioxide and the chemical are discharged to the gas-liquid separation-collection device 61 through the three-way valve 50 and the second pressure control valve 52 until the chemical is stably and homogeneously dissolved.

The chemical is completely dissolved in the supercritical carbon dioxide until the interface between the two phases may not be observed from the solubility observation window 42. The three-way valve 50 is switched to from the pipe 75 and the pipe 74, so that a fluid from the mixing tank 40 may be supplied to the treatment tank 11.

The supercritical carbon dioxide in which the chemical is completely dissolved is supplied to the treatment tank 11 from the mixing tank 40 through the pipe 73, the three-way valve 50, the pipe 74, and the heating device 16. At this time, the pressure of the fluid is automatically reduced to a predetermined treatment pressure in the treatment tank 11.

A surface of the substrate 100 is supercritically treated with the supercritical carbon dioxide containing the chemical in the treatment tank 11. At this time, the temperature of the fluid in the treatment tank 11 is controlled by the heating device 15 equipped with a temperature controller.

When the pressure in the treatment tank 11 is a predetermined treatment pressure or higher, the first pressure control valve 51 is opened, so that the supercritical carbon dioxide containing the chemical is discharged to the gas-liquid separation-collection device 60 through the heating device 17 and the first pressure control valve 51.

The pressure and temperature in the treatment tank 11 may be kept constant when the supercritical carbon dioxide with which the treatment tank 11 is filled is appropriately discharged in this manner.

A fluid discharged to the gas-liquid separation-collection device 60 from the first pressure control valve 51 and a fluid discharged to the gas-liquid separation-collection device 61 from the second pressure control valve 52 are adiabatically expanded by the pressure control valves 51 and 52, so that a pressure of the fluids is returned to atmospheric pressure. When the pressure of the fluid is returned to atmospheric pressure, the carbon dioxide in a supercritical state is transformed into a gas, so that the fluid may be separated into carbon dioxide gas and a liquid chemical.

The chemical separated from the carbon dioxide is collected in the gas-liquid separation-collection devices 60 and 61 as a discharged liquid. A substance removed or extracted with the supercritical fluid in the treatment tank 11 is dissolved in or accompanied with the chemical and accumulated in the gas-liquid separation-collection device 60.

On the other hand, the carbon dioxide is discharged from the gas-liquid separation-collection devices 60 and 61 as a gas. The discharged carbon dioxide also may be condensed again and collected.

The collected chemical or carbon dioxide also may be reprocessed to be usable and reused.

In the treatment apparatus and the treatment method according to the above-described first embodiment of the present invention, the pressure for mixing a supercritical fluid with a chemical may be optionally determined independently from the treatment apparatus main body 10.

The solubility of the chemical in the supercritical fluid depends on the pressure when the chemical is mixed with the supercritical fluid. Therefore, as the pressure when the chemical is mixed with the supercritical fluid is increased, the solubility of the chemical is increased.

In the above-described treatment apparatus and treatment method, a supercritical fluid may be mixed with a chemical under a high pressure in the mixing tank 40, so that the supercritical fluid may be homogeneously and efficiently mixed with the chemical even when the flow rate of the supercritical fluid is high.

Accordingly, the efficiency in treating a substrate may be improved by increasing the flow rate of the supercritical fluid.

Since the supercritical fluid is mixed with the chemical under a high pressure in a route differing from the treatment tank 11 before supplying the supercritical fluid and the chemical to the treatment apparatus main body 10, a pressure in the treatment tank 11 does not have to be increased to a pressure for treatment or higher. Thus, it is possible to prevent damage to the treatment tank 11 that is caused by allowing the pressure in the treatment tank 11 to be high. Further, since it may not be necessary to increase the pressure in the treatment tank 11 to a pressure for treatment or higher, a normal treatment tank may be used, and a high-pressure proof treatment tank does not have to be used. Thus, the treatment apparatus and method are advantageous in terms of equipment and cost.

As the pressure in the treatment tank 11 is higher, the reactivity of a chemical is higher. Therefore, when the pressure in the treatment tank 11 is increased to a pressure for treatment or higher, the reactivity of the chemical is too high, and treatment, such as etching, is performed even for part of a substrate 100 which may not need such treatment. Accordingly, when the pressure in the treatment tank 11 is high, it is difficult to uniformly treat a substrate.

In contrast, in the above-described method, since the pressure in the treatment tank 11 may not need to be increased to a pressure for treatment or higher, the reactivity of the chemical is not too high. Thus, it is possible to prevent damages to a substrate caused by reaction of the chemical.

Further, the above-described treatment apparatus has the three-way valve 50, so that a fluid supplied from the mixing tank 40 may be optionally switched between the treatment tank 11 and the second pressure control valve 52. Thus, when a supercritical fluid is not homogeneously mixed with a chemical, the three-way valve 50 is switched to the second pressure control valve 52, so that the nonhomogeneous supercritical fluid is not supplied to the treatment tank 11.

Accordingly, it is possible to prevent a substrate from being non-uniformly treated due to a supply of the nonhomogeneous supercritical fluid.

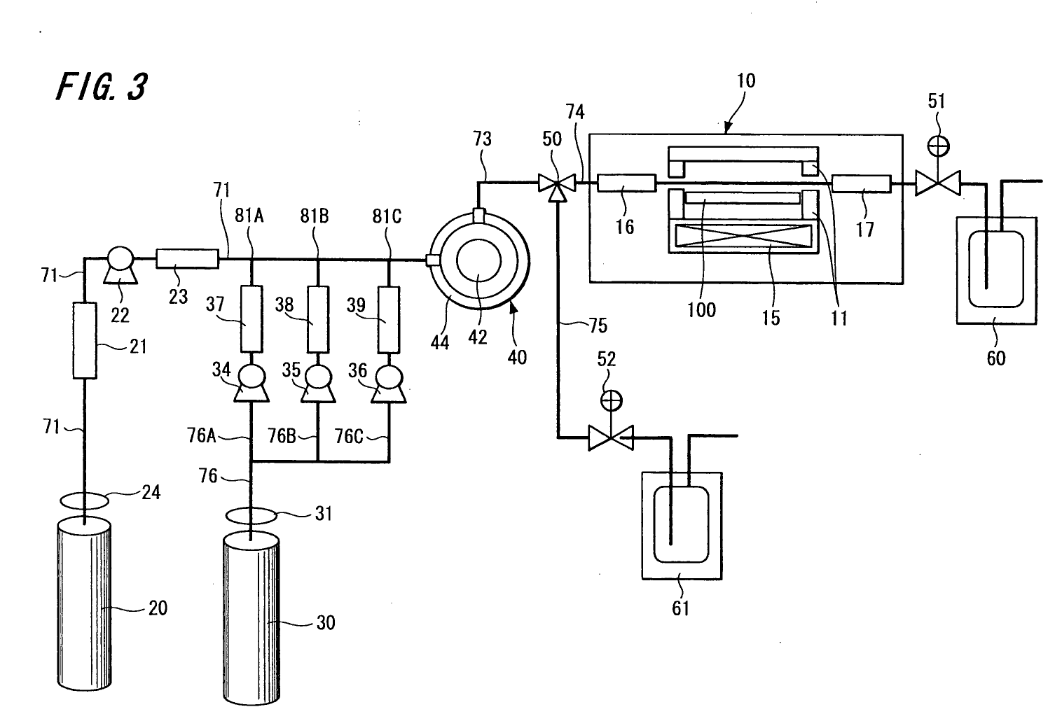

Next, a treatment apparatus according to a second embodiment of the present invention is shown in FIG. 3.

The treatment apparatus of FIG. 3 is a single wafer process apparatus and has a treatment apparatus main body 10, a carbon dioxide supply device 20, a chemical supply device 30, a mixing tank 40, a three-way valve 50, and gas-liquid separation-collection devices 60 and 61. The carbon dioxide supply device 20 supplies carbon dioxide to the treatment apparatus main body 10. The chemical supply device 30 supplies a second chemical substance (chemical,) such as an etchant, solubilizer, or cleaner, to the treatment apparatus main body 10. The mixing tank 40 dissolves the supercritical carbon dioxide and the chemical to be supplied to the treatment apparatus main body 10. The gas-liquid separation-collection devices 60 and 61 separate the discharged supercritical carbon dioxide into carbon dioxide gas and a chemical to collect the chemical and the carbon dioxide.

The treatment apparatus main body 10 is formed as a plate-like container and has a treatment tank 11 in which a substrate 100 to be treated is accommodated and treated; and a heating device 15 is incorporated in the treatment tank 11. The main body has heating devices 16 and 17 in front of and behind the treatment tank 11.

A first pressure control valve 51 for controlling the pressure in the treatment apparatus main body 10 and the gas-liquid separation-collection device 60 for separating a fluid discharged from the treatment apparatus main body 10 into carbon dioxide gas and a chemical and to collect the chemical are provided downstream of the treatment apparatus main body 10.

The carbon dioxide supply device 20 is formed of a carbon dioxide cylinder in which pressurized and liquidated carbon dioxide is contained.

An opening-closing valve 24 is provided for the carbon dioxide supply device 20. A pipe 71 is connected to the carbon dioxide supply device 20. The pipe 71 connects the carbon dioxide supply device 20, a cooling device 21 for cooling to liquidize CO₂ gas, and a pressurizing device 22 and a heating device 23 for transforming the liquid carbon dioxide into a supercritical state to each other, and is connected to the mixing tank 40.

The pressurizing device 22 is formed of a pressurizing pump or the like, and the heating device 23 is formed of a line heater or the like.

An opening-closing valve 31 is provided for the chemical supply device 30. A pipe 76 is connected to the chemical supply device 30. The pipe 76 is formed so as to be branched to a pipe 76A, a pipe 76B, and a pipe 76C.

The pipe 76A, the pipe 76B, and the pipe 76C have a pressurizing device 34, a pressuring device 35, and a pressurizing device 36, respectively, and have a heating device 37, a heating device 38, and a heating device 39, respectively. The pipes 76A, 76B, and 76C connect the pipe 71 in which supercritical carbon dioxide flows with the pipe 76.

Since supercritical carbon dioxide flowing in the pipe 71 is brought into contact with a chemical flowing in the pipe 76A, the pipe 76B, and the pipe 76C in junctions of the pipe 71 and the pipe 76A, the pipe 76B, and the pipe 76C, the junctions form a mixing device 81A, a mixing device 81B, and a mixing device 81C for mixing the supercritical carbon dioxide with the chemical.

The mixing tank 40 has a solubility observation window 42 for observing whether or not carbon dioxide is mixed with an additive; and a heating device 44 such as a built-in heater is incorporated in an outer wall of the tank.

The pipe 71 into which a fluid mixture of supercritical carbon dioxide with a chemical flows and a pipe 73 from which the fluid is discharged are connected to the mixing tank 40.

The three-way valve 50 is provided between the mixing tank 40 and the treatment apparatus main body 10. The three-way valve 50 is formed to connect the pipe 73 at the side of the mixing tank 40 to a pipe 74 at the side of the treatment apparatus main body 10 and branch a pipe 75 from the pipe 73 and the pipe 74.

The three-way valve 50 is formed so that a supply route of a fluid flowing from the pipe 73 at the side of the mixing tank 40 may be switched between the pipe 74 and the pipe 75.

A second pressure control valve 52 is provided for the pipe 75 divided by the three-way valve 50. The gas-liquid separation-collection device 61 for separating a fluid discharged through the three-way valve 50 and the second pressure control valve 52 into carbon dioxide gas and a chemical and to collect the chemical is provided for the pipe 75.

The second pressure control valve 52 has a configuration in which the valve may control the pressure in the mixing tank 40 and the mixing devices 81A, 81B, and 81C independently from the treatment apparatus main body 10 when the three-way valve 50 blocks the pipe 74 and connects the pipe 73 to the pipe 75.

Next, a method for treating a substrate using the treatment apparatus according to the above-described second embodiment will be described.

First, a substrate 100 to be treated is accommodated in the treatment tank 11 and the cover is closed, so that the treatment tank 111 is sealed.

Then, the first pressure control valve 51 is adequately closed so that the pressure in the treatment tank 11 may be controlled to be a predetermined treatment pressure (26 MPa, for example). The three-way valve 50 is switched so that a fluid from the pipe 73 is supplied to the pipe 74.

Then, the opening-closing valve 24 is opened to supply carbon dioxide from the carbon dioxide supply device 20. The carbon dioxide supplied from the carbon dioxide supply device 20 is cooled using the cooling device 21 and transformed into a liquid state. The carbon dioxide in a liquid state is pressurized to 7.3 MPa or higher by the pressurizing device 22 and heated to 50° C. by the heating device 23 and thus is transformed into a supercritical state.

The carbon dioxide in a supercritical state is introduced into the treatment apparatus main body 10 through the mixing tank 40 and the three-way valve 50. The pressure in the treatment tank 11 is controlled so as to be a pressure for treating the substrate 100 (26 MPa, for example) by the first pressure control valve 51. At this time, when the pressure in the treatment tank 11 is a predetermined pressure or higher, the first pressure control valve 51 is opened, so that the pressure in the treatment tank 11 may be kept constant. The supercritical carbon dioxide discharged from the treatment tank 11 is discharged to the gas-liquid separation-collection device 60 by opening the first pressure control valve 51.

Subsequent treatment of the substrate may be rapidly performed by pre-controlling the pressure in the treatment tank 11 to be a predetermined treatment pressure.

Then, a flow of the supercritical carbon dioxide from the pipe 73 is switched to the pipe 75 from the pipe 74 by the three-way valve 50. Then, the second pressure control valve 52 is adequately closed so that the pressure in the mixing tank 40 may be controlled to be higher than the treatment pressure in the treatment tank 11 (30 MPa, for example).

After a certain time, the pressure in the mixing tank 40 is higher than the treatment pressure in the treatment tank 11 by the supercritical carbon dioxide supplied from the pipe 71.

Then, the opening-closing valve 31 is opened to supply a chemical from the chemical supply device 30.

The chemical supplied from the chemical supply device 30 is divided and flows into the pipe 76A, the pipe 76B, and the pipe 76C from the pipe 76. The chemical is controlled so as to be at a predetermined pressure and temperature by the pressurizing devices 34, 35, and 36 and the heating devices 37, 38, and 39 provided for the respective pipes, and is supplied to the pipe 71. At this time, the chemical is mixed at a ratio of 1 to 5 wt % in total based on the carbon dioxide already heated and pressurized, for example.

The amount of the chemical supplied is determined by the pressurizing devices 34, 35, and 36 so that a concentration of the chemical is decreased from upstream to downstream. For example, 50% of the total amount added is supplied from the pressurizing device 34, 30% of the total amount added is supplied from the pressurizing device 35, and 20% of the total amount added is supplied from the pressurizing device 36.

When the chemical is mixed at a concentration of 5 wt % based on the supercritical carbon dioxide, for example, the chemical is supplied from the pipe 76A at a concentration of 2.5 wt % based on the supercritical carbon dioxide, from the pipe 76B at 1.5 wt % based on the supercritical carbon dioxide, and from the pipe 76C at a concentration of 1 wt % based on the supercritical carbon dioxide.

A method of supplying the chemical to the pipe 71 in the second embodiment will be described.

First, 50% of the total amount of the chemical supplied from the pipe 76 is supplied to the pipe 71 from the pipe 76A by the pressurizing device 34. At this time, the pressurizing devices 35 and 36 are unoperated, and the chemical is not supplied from the pipe 76B and the pipe 76C.

The chemical from the pipe 76A is brought into contact with the supercritical carbon dioxide in the pipe 71 in the mixing device 81A and is supplied to the mixing tank 40 through the pipe 71.

Subsequently, after the chemical supplied from the pipe 76A is stably and homogeneously mixed with the supercritical carbon dioxide, 30% of the total amount of the chemical supplied is supplied to the pipe 71 from the pipe 76B by the pressurizing device 35. At this time, the chemical is continuously supplied from the pipe 76A. The pressurizing device 35 is unoperated, and the chemical is not supplied from the pipe 76C.

The chemical from the pipe 76B is brought into contact with the supercritical carbon dioxide in the mixing device 81B and is supplied to the mixing tank 40 through the pipe 71.

Subsequently, after the chemical supplied from the pipe 76B is stably and homogeneously mixed with the supercritical carbon dioxide, 20% of the total amount of the chemical supplied is supplied to the pipe 71 from the pipe 76C by the pressurizing device 36. At this time, the chemical is continuously supplied from the pipe 76A and the pipe 71B.

The chemical from the pipe 76C is brought into contact with the supercritical carbon dioxide in the mixing device 81C and is supplied to the mixing tank 40 through the pipe 71.

In this manner, the chemical supplied from the chemical supply device 30 and the pipe 76 may be mixed with the supercritical carbon dioxide in the pipe 71 using the pipe 76A, the pipe 76B, and the pipe 76C while changing the concentration of the chemical stepwise.

Thus, excellent solubility may be achieved by mixing the chemical stepwise when it is difficult to dissolve a predetermined concentration of the chemical in the supercritical carbon dioxide at one time.

The chemical supplied from the pipe 76A, the pipe 76B, and the pipe 76C is not homogeneously mixed with the supercritical carbon dioxide for a certain time. Thus, a phase of the supercritical carbon dioxide and a phase of the chemical are separated in the mixing tank 40, and an interface between the two phases may be observed from the solubility observation window 42.

After supplying the chemical from the pipe 76C, the supercritical carbon dioxide and the chemical are discharged to the gas-liquid separation-collection device 61 through the three-way valve 50 and the second pressure control valve 52 until the chemical is stably and homogeneously dissolved.

The chemical is completely dissolved in the supercritical carbon dioxide until the interface between the two phases may not be observed from the solubility observation window 42. The three-way valve 50 is switched to the pipe 74 from the pipe 75, so that a fluid from the mixing tank 40 may be supplied to the treatment tank 11.

The supercritical carbon dioxide in which the chemical is completely dissolved is supplied to the treatment tank 11 from the mixing tank 40 through the pipe 73, the three-way valve 50, the pipe 74, and the heating device 16. At this time, the pressure of the fluid is automatically reduced to a predetermined treatment pressure in the treatment tank 11.

A surface of the substrate 100 is supercritically treated with the supercritical carbon dioxide containing the chemical in the treatment tank 11. At this time, the temperature of the fluid in the treatment tank 11 is controlled by the heating device 15 equipped with a temperature controller.

When the pressure in the treatment tank 11 is a predetermined treatment pressure or higher, the first pressure control valve 51 is opened, so that the supercritical carbon dioxide containing the chemical is discharged to the gas-liquid separation-collection device 60 through the heating device 17 and the first pressure control valve 51.

The pressure and temperature in the treatment tank 11 may be kept constant when the supercritical carbon dioxide with which the treatment tank 11 is filled is appropriately discharged in this manner.

A fluid discharged to the gas-liquid separation-collection device 60 from the first pressure control valve 51 and a fluid discharged to the gas-liquid separation-collection device 61 from the second pressure control valve 52 are adiabatically expanded by the pressure control valves 51 and 52, so that a pressure of the fluids is returned to atmospheric pressure. When the pressure of the fluid is returned to atmospheric pressure, the carbon dioxide in a supercritical state is transformed into a gas, so that the fluid may be separated into carbon dioxide gas and a liquid chemical.

The chemical separated from the carbon dioxide is collected in the gas-liquid separation-collection devices 60 and 61 as a discharged liquid. A substance removed or extracted by the supercritical fluid in the treatment tank 11 is dissolved in or accompanied with the chemical and accumulated in the gas-liquid separation-collection device 60.

On the other hand, the carbon dioxide is discharged from the gas-liquid separation-collection devices 60 and 61 as a gas. The discharged carbon dioxide also may be condensed again and collected.

The collected chemical or carbon dioxide also may be reprocessed so as to be usable and reused.

The treatment apparatus and the treatment method according to the above-described second embodiment may exhibit an effect similar to that exhibited by the treatment apparatus and the treatment method according to the first embodiment.

Further, in the treatment apparatus and the treatment method according to the second embodiment, a chemical to be supplied is divided into multiple portions and then mixed stepwise with supercritical carbon dioxide, so that the chemical may be more homogeneously mixed with the supercritical carbon dioxide.

Therefore, the treatment apparatus and method are advantageous for homogeneously mixing supercritical carbon dioxide with a chemical when efficiency in treating a substrate is improved using a higher flow rate of supercritical carbon dioxide.

In the above-described second embodiment, the pipe 76 is branched to the pipe 76A, the pipe 76B, and the pipe 76C. However, the number of branches is not limited to three. The above effect may be achieved when the number of branches is two or more.

In the first and second embodiments, supercritical carbon dioxide is mixed by a chemical in the mixing tank 40. However, supercritical carbon dioxide may be mixed with a chemical by in-line injection without using the mixing tank 40. When supercritical carbon dioxide is mixed with a chemical by in-line injection, the mixing tank 40 does not have to be used, and the treatment apparatus may have a simplified configuration.

The present invention is not limited to the above-described configuration, and various other configurations are possible without departing from the gist of the present invention.

It should be understood by those skilled in the art that various modifications, combinations, subcombinations and alterations may occur depending on design requirements and other factors insofar as they are within the scope of the appended claims or the equivalents thereof.

What is claimed is:

1. A method for treating a substrate using a supercritical fluid as a medium, the method comprising the steps of:
mixing the supercritical fluid with a chemical under a pressure higher than a pressure for treating the substrate; and
subsequently treating the substrate with the supercritical fluid mixed with the chemical under the pressure for treating the substrate.

2. The method for treating a substrate according to claim 1, wherein
the chemical is supplied to the supercritical fluid in a multiple-stepwise fashion when the supercritical fluid is mixed with the chemical.

3. The method for treating a substrate according to claim 2, wherein
an amount of the chemical supplied at an upstream side of the supercritical fluid is greater than an amount of the chemical supplied at a downstream side of the supercritical fluid when the chemical is supplied in a multiple-stepwise fashion.

4. The method for treating a substrate according to claim 1, wherein
supercritical carbon dioxide is used as the supercritical fluid.

5. An apparatus for treating a substrate, comprising:
a substrate treatment tank formed to accommodate a substrate into which a supercritical fluid is introduced as a medium to treat the substrate; and
a mixing device for mixing the supercritical fluid with a chemical provided upstream of the substrate treatment tank, wherein
a pipe divided by a branching valve is provided between the substrate treatment tank and the mixing device, and
the pipe divided by the branching valve has a pressure control valve.

6. The apparatus for treating a substrate according to claim 5, comprising:
a plurality of mixing devices for mixing the supercritical fluid with the chemical.
